(19) United States
(12) Patent Application Publication
(10) Pub. No.: US 2005/0017490 A1
(43) Pub. Date: Jan. 27, 2005

(54) Hybrid inflator

(75) Inventor: Masayuki Yamazaki, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-shi (JP)

(21) Appl. No.: 10/895,309

(22) Filed: Jul. 21, 2004

(30) Foreign Application Priority Data
Jul. 22, 2003 (JP) 2003-277358

(51) Int. Cl. B60R 21/28

(52) U.S. Cl. 280/741

(57) ABSTRACT

To provide a hybrid inflator in which the combustibility of a second gas generating agent is improved. Some of the openings 121a out of second openings 121 are shielded with tape 132, and the opening area A_{2nd-1} of the remaining openings and the opening area Aₑₓ of an opening portion 131 of a recessed portion of a partition member for controlling an outflow pressure of gas satisfy the relationship Aₑₓ>A_{2nd-1}, whereby the pressure inside a second combustion chamber 120 readily rises upon burning the second gas generating agent 119. The combustibility of the second gas generating agent 119 is thus favorable even when a pressurized medium has been discharged and hence the internal pressure has become equal to atmospheric pressure.

### TECHNICAL FIELD

The present invention relates to a hybrid inflator suitable for use in an air bag system installed in a motor vehicle, and such an air bag system.

### PRIOR ART

With a dual type hybrid inflator having two combustion chambers, the gas generating agents housed in the two combustion chambers are set to be burnt either simultaneously or with one delayed in accordance with the degree of impact to which a passenger is subjected upon collision of a motor vehicle. Furthermore, if the collision of the motor vehicle is light, and hence the impact to which the passenger is subjected is light, the air bag may be inflated by burning only one of the gas generating agents, but even in this case, in consideration of the safety of work when subsequently disposing of the motor vehicle, the remaining unburnt gas generating agent is also burnt, with this being unrelated to the inflation of the air bag to protect the passenger.

This burning of the unburnt gas generating agent is commenced after a delay of approximately 100 ms from the burning of the first gas generating agent, and at this time most of the pressurized medium in the hybrid inflator has already been discharged, and hence the pressure inside the inflator has become approximately equal to atmospheric pressure. In general, the burning rate of a gas generating agent tends to be higher, the higher the pressure is, and hence in the above case it becomes that the gas generating agent burns with difficulty.

Furthermore, when the burning of the unburnt gas generating agent is commenced and hence high-temperature combustion gas is generated, the pressure inside the inflator increases somewhat; however, openings of the hybrid inflator (gas discharge ports and an opening portion near thereto) are set to have an opening size (opening area) for the state in which the pressurized medium is present inside, and thus the opening area is too large relative to the total surface area of the unburnt gas generating agent, and hence the internal pressure is not increased to an extent that the burning of the gas generating agent is promoted well.

In the case that the unburnt gas generating agent is burnt under atmospheric pressure in this way, the burning time may be too long, and gas components such as CO and NOₓ may be generated due to the insufficient pressure.

In U.S. Pat. No. 5,582,428 there is disclosed a hybrid inflator in which, in a housing, a second chamber is further provided in a first chamber charged with a pressurized medium, and opening portions of the first chamber and the second chamber are each closed off by a rupturable plate. The first and second chambers are communicated together by a flow path, but this flow path is for moving the pressurized medium over a long time and thus equalizing the pressures in the two chambers, and is not for moving the pressurized medium in a short time (see column 7, lines 35 to 40, etc.). When the igniter of the first chamber is actuated, the rupturable plate is ruptured, and the pressurized medium inside the first chamber flows out to the outside, the inside of the second chamber is thus still maintained in a high-pressure state.

Consequently, with this art, the problem described above does not arise, but on the other hand there are problems predominantly in terms of manufacture in that a double structure of the first chamber and the second chamber must be adopted, the first chamber and the second chamber must be separately closed off with rupturable plates, and a long time is required for the pressures in the first chamber and the second chamber to be equalized. Furthermore, considering that the pressure in the first chamber will drop down to approximately atmospheric pressure when only the gas in the first chamber is discharged, the rupturable plate partitioning the first chamber and the second chamber from one another must be sufficiently thick to be able to withstand the pressure difference between the two chambers. It is thought that if such a thick rupturable plate is used, then when the first chamber and the second chamber are actuated simultaneously, the rupturable plate of the second chamber will rupture with difficulty, and hence it will become necessary to install an igniter having a very large output in the second chamber.

Moreover, in U.S. Pat. No. 6,206,414 there is disclosed a hybrid inflator in which two combustion chambers are provided inside a housing charged with a pressurized medium, and each is subjected to ignition and burning using an igniter independently. Each of the combustion chambers is communicated with the inside of the housing by openings, with the openings not being sealed with a rupturable plate or the like. Moreover, two gas discharge ports that are sealed with a rupturable plate are formed in the housing, and when only the gas generating agent in one of the combustion chambers is burnt, only the rupturable plate sealing one of the gas discharge ports is ruptured, and the gas is discharged.

In this state, after most of the pressurized medium has been discharged, the inside of the housing is in a state close to atmospheric pressure, and hence the pressure is insufficient when the unburnt gas generating agent is consumed, causing the production of gases such as CO and NOₓ.

### DISCLOSURE OF THE INVENTION

A problem to be solved is, with a hybrid inflator in which are provided plural combustion chambers each having a gas generating agent therein, to increase the pressure inside the inflator housing when ignition and burning are carried out after a delay, thus improving the gas generating agent combustion performance, and hence suppressing the production of gases such as CO and NOₓ.

The present invention solves the above problem with a dual type hybrid inflator having two combustion chambers, but can also be applied to a hybrid inflator having three or more combustion chambers.

Moreover, ‘the combustibility of the gas generating agent burnt after a delay is improved’ in the present invention means that when, after a delay of approximately 100 milliseconds from the commencement of burning of the gas generating agent in one of the combustion chambers, the gas generating agent in the other combustion chamber is burnt, with this not being for expanding the air bag to restrain a passenger (i.e. when the gas generating agent in the other combustion chamber is burnt in a state in which the pressurized medium inside the hybrid inflator has substantially been ejected into the air bag, and hence the pressure inside the housing has become approximately equal to atmospheric pressure), the burning rate of the other gas generating agent is increased, and hence the burning is completed promptly, and moreover the production of gases such as CO and NOₓ is suppressed.

As means for solving the above problem, the present invention provides a hybrid inflator for inflating an air bag, in which the combustibility of a gas generating agent burnt after a delay is improved, the hybrid inflator comprising an inflator housing, a first combustion chamber and a second combustion chamber housed in the inflator housing, a first ignition means and a second ignition means connected to the respective combustion chambers, and gas discharge ports from which a gas is discharged;
wherein a pressurized medium charged space inside the inflator housing is charged with a pressurized medium;
a gas discharge path for ejecting a gas containing the pressurized medium into an air bag is provided, and an opening portion for controlling an outflow pressure of the gas is provided in the gas discharge path;
for each of the first combustion chamber and the second combustion chamber, an outer shell is formed through a combustion chamber housing having plural communication holes therein, a first gas generating agent and a second gas generating agent are housed respectively therein, and each of the two combustion chambers is communicated with the pressurized medium charged space of the inflator housing by the plural communication holes;
out of the two combustion chambers, the second combustion chamber, in which the gas generating agent is burnt after a delay, has some of the plural communication holes closed off with a shielding means;
and the total area A_{2nd-1} of the non-shielded open communication holes, and the total area Aₑₓ of the opening portion provided in the gas discharge path for controlling the outflow pressure of the gas satisfy the following formula (I):
   Aₑₓ>A_{2nd-1} (I).

In general, the burning rate of a gas generating agent is proportional to the pressure. When the pressurized medium has been charged in, then when the first and second gas generating agents are burnt simultaneously or with the burning of the second gas generating agent delayed slightly, the pressurized medium is present in both the first and second combustion chambers, and hence the first and second gas generating agents are each subjected to a pressure P₁ (a pressure approximately equal to the charging pressure of the pressurized medium). If the first and second gas generating agents are burnt in the state of this pressure P₁ a burning rate r₁ corresponding to the pressure P₁ is obtained.

The amount of gas generated from the first and second combustion chambers per unit time thus becomes an amount of gas corresponding to the pressure P₁ and the burning rate r₁, and hence a high-pressure state is formed in the first and second combustion chambers in a relatively short time. Consequently, out of the communication holes in the second combustion chamber, the closed off communication holes also open up due to the shielding means rupturing, and hence the burning of the second gas generating agent can be completed in a prescribed time (corresponding approximately to the air bag inflation time), and thus the production of gases such as CO and NOₓ can be suppressed.

On the other hand, in the case that only the first gas generating agent is burnt upon a collision of the motor vehicle, from the viewpoint of securing safety during work of disposing of the motor vehicle, it is necessary to burn and thus dispose of the remaining second gas generating agent approximately 100 milliseconds after the burning of the first gas generating agent. In this case, most of the pressurized medium inside the second combustion chamber has flowed out and hence the pressure in the second combustion chamber has dropped down to approximately atmospheric pressure, and thus the gas generating agent is subjected to a pressure P₂ of approximately atmospheric pressure, and hence the gas generating agent starts to burn at a burning rate r₂ corresponding to the pressure P₂.

However, because some of the communication holes possessed by the second combustion chamber are closed off, the combustion gas generated through the burning of the second gas generating agent is impeded from flowing out by the closed up communication holes, and hence the pressure inside the second combustion chamber increases (P₂→P₃), and thus the burning rate increases (r₂→r₃). However, P₃<P₁ and r₃<r₁, and hence the amount of combustion gas per unit time is less than when the pressurized medium is present (the case of P₁ and r₁), and thus the pressure rise in the second combustion chamber is gradual, and hence the communication holes closed off by the shielding means are not opened, and thus the combustion gas flows out from only the open communication holes.

At this time, if formula (I) were not satisfied but rather Aₑₓ was less than A_{2nd-1}, then the outflow rate of the combustion gas generated from the second combustion chamber would be controlled by the opening portion provided in the gas discharge path (Aₑₓ), and hence the pressure rise in the second combustion chamber would not be sufficient, and thus the burning rate would drop (i.e. the pressure and the burning rate would become less than P₃ and r₃ respectively)

However, by satisfying the relationship of formula (I), in the case that the gas generating agent in the second combustion chamber is burnt after most of the pressurized medium has been discharged from the inflator housing together with the combustion gas generated from the first combustion chamber and hence the internal pressure has dropped down to approximately atmospheric pressure, the outflow of the combustion gas generated in the second combustion chamber is controlled by the closed up communication holes (A_{2nd-1}), resulting in a pressure rise in the second combustion chamber, and hence there is an effect of the burning rate of the gas generating agent housed in the second combustion chamber being increased, and the production of CO and NOₓ being suppressed.

The present invention provides a hybrid inflator for air bag inflation, in which the combustibility of a gas generating agent burnt after a delay is improved, comprising:
an inflator housing formed with a gas discharge port, and defining a space filled with a pressurized medium;
a first combustion chamber housing provided within the inflator housing and defining therein a first combustion chamber including a first gas generating agent, the first combustion chamber housing being provided with a plural communication holes connecting the first combustion chamber to the space;
a second combustion chamber housing provided within the inflator housing and defining therein a second combustion chamber including a second gas generating agent that is ignited later than the first gas generating agent, the second combustion chamber housing being provided with a non-shielded open communication holes connecting the second combustion chamber and the space and a shielded communication holes connecting the second combustion chamber and the space when the shielded communication holes open, the non-shielded open communication holes having a total open area A_{2nd-1};
a first ignition means connected to the first combustion chamber;
a second ignition means connected to the second combustion chambers,
a gas discharge path connecting the gas discharge port to the space, and including an opening portion for controlling an outflow of the pressurized medium, the opening portion having a total area Aₑₓ satisfying the following formula (I):
   Aₑₓ>A_{2nd-1} (I)

With the present invention, in the case of the hybrid inflator, it is preferably made to be such that out of the plural communication holes possessed by the second combustion chamber, the total area A_{2nd-1} of the non-shielded open communication holes is no more than 50% of the sum A_{2nd} of the total area A_{2nd-2} of the shielded communication holes and the total area A_{2nd-1} of the non-shielded open communication holes, whereby the effect described above can be made yet smoother.

With the present invention, in the case of the hybrid inflator, the total area A₁ₛₜ of the plural communication holes possessed by the first combustion chamber accommodating the gas generating agent that is burnt first, and Aₑₓ preferably satisfy the following formula (II):
Aₑₓ<A₁ₛₜ (II).

In the case that only the gas generating agent in the first combustion chamber is burnt, by making the total opening area Aₑₓ of the opening portion provided in the gas discharge path for controlling the outflow pressure of the gas be lower than the total opening area A₁ₛₜ of the communication holes possessed by the first combustion chamber, the outflow amount (outflow pressure, outflow rate) of the pressurized medium and the combustion gas can be controlled by the opening portion provided in the gas discharge path. Consequently, when only the gas generating agent in the first combustion chamber is burnt, and then the gas generating agent in the second combustion chamber is burnt approximately 100 milliseconds thereafter, it is preferable for formula (II) to be satisfied as well as formula (I).

With the present invention, in the case of the hybrid inflator, A₁ₛₜ, A_{2nd-1}, A_{2nd-2} and Aₑₓ preferably satisfy the following formulae (III) to (V):
Aₑₓ<A₁ₛₜ+A_{2nd-1}+A_{2nd-2} (III)
A₁ₛₜ>Aₑₓ×[S₁/(S₁+S₂)] (IV)
A_{2nd-1}+A_{2nd-2}>Aₑₓ×[S₂/(S₁+S₂)] (V)
[wherein S₁ represents the total surface area of the first gas generating agent burnt first, and S₂ represents the total surface area of the second gas generating agent burnt after a delay].

When the first and second gas generating agents are burnt simultaneously, if the relationship of formula (III) is satisfied, then the outflow amount (outflow pressure, outflow rate) of all the gas comprising the combustion gas generated from the first and second combustion chambers and the pressurized medium can be controlled by only the opening portion in the gas discharge path (Aₑₓ) Note that at this time, the shielding means will be ruptured, and hence all of the communication holes of the second combustion chamber will be opened.

The first and second gas generating agents in the first and second combustion chambers are burnt independently of one another, and hence it is preferable for the respective opening areas of the communication holes A₁ₛₜ, and A_{2nd-1} and A_{2nd-2} to satisfy formulae (IV) and (V) with regard to the relationship with the total surface areas of the first and second gas generating agents (S₁ and S₂) (the greater the surface area, the greater the amount of gas generated per unit time).

With the present invention, in the case of the hybrid inflator, the above-mentioned opening portion is preferably formed in a partition member provided in a central portion of the inflator housing.

As another means for solving the problem, the present invention provides an air bag system comprising an actuation signal outputting means, which comprises an impact sensor and a control unit, and a module case in which are housed an air bag and the above mentioned hybrid inflator.

There are no particular limitations on the combustion chambers provided inside the housing of the hybrid inflator of the present invention, but one form thereof is described below. The gas generating agents housed in the two combustion chambers in the hybrid inflator of the present invention can be decided in connection with the composition of the pressurized medium charged into the inflator housing.

The pressurized medium comprises inert gases such as argon or helium (in the present invention, nitrogen is also deemed to be included under inert gases). Of these, argon acts to promote thermal expansion of the pressurized medium, and if helium is contained then it becomes easy to detect leakage of the pressurized medium, which is preferable since then distribution of defective products can be prevented. Moreover, helium only may also be used as the pressurized medium. The charging pressure of the pressurized medium is preferably 10,000 to 70,000 kPa, more preferably 30,000 to 60,000 kPa.

As each gas generating agent, for example one that contains a fuel and an oxidizing agent, or a fuel, an oxidizing agent and a slag-forming agent, and has been mixed together with a binding agent as required and then formed into a desired shape can be used; when such a gas generating agent is used, the gas generated through the burning thereof can be used for inflation of an air bag together with the pressurized medium. In particular, when a gas generating agent containing a slag-forming agent is used, the amount of mist discharged from the inflator can be greatly reduced.

As the fuel, at least one selected from the group consisting of guanidine derivatives such as nitroguanidine (NQ), guanidine nitrate (GN), guanidine carbonate, aminonitroguanidine, aminoguanidine nitrate, aminoguanidine carbonate, diaminoguanidine nitrate, diaminoguanidine carbonate, and triaminoguanidine nitrate is preferable. Moreover, at least one selected from the group consisting of tetrazole and tetrazole derivatives can also be used as the fuel.

As an oxidizing agent, at least one selected from the group consisting of strontium nitrate, potassium nitrate, ammonium nitrate, potassium perchlorate, copper oxide, iron oxide, basic copper nitrate and so on is preferable. The amount blended in of the oxidizing agent is preferably 10 to 80 parts by weight, more preferably 20 to 50 parts by weight, per 100 parts by weight of the fuel.

As a slag-forming agent, at least one selected from the group consisting of acid clay, talc, bentonite, diatomaceous earth, kaolin, silica, alumina, sodium silicate, silicon nitride, silicon carbide, hydrotalcite, and mixtures thereof is preferable. The amount blended in of the slag-forming agent is preferably 0 to 50 parts by weight, more preferably 1 to 10 parts by weight, per 100 parts by weight of the fuel.

As a binding agent, at least one selected from the group consisting of a sodium salt of carboxymethyl cellulose, hydroxyethyl cellulose, starch, polyvinyl alcohol, guar gum, microcrystalline cellulose, polyacrylamide, calcium stearate and so on is preferable. The amount blended in of the binding agent is preferably 0 to 30 parts by weight, more preferably 3 to 10 parts by weight, per 100 parts by weight of the fuel.

When using the pressurized medium and the gas generating agent having compositions as above, the molar ratio (A/B) of the amount of the pressurized medium (A mol) and the amount of gas generated through burning the gas generating agent (B mol) is preferably adjusted to be 8/2 to 1/9, more preferably 8/2 to 3/7.

By adjusting the molar ratio of the amount of the pressurized medium charged into the hybrid inflator and the amount of gas generated through burning the gas generating agent in this way, the amount of the pressurized medium charged in can be reduced. Consequently, even in the case that the volume of the housing is reduced (i.e. the length and/or width (diameter) of the housing is/are reduced), the same pressure as before reducing the volume can be maintained, without increasing the charging pressure of the pressurized medium (=the pressure inside the housing). Alternatively, by reducing the amount charged in (the charging pressure) of the pressurized medium, the thickness of the vessel storing the pressurized medium can be reduced, and hence the weight can be reduced. Note that with the hybrid inflator of the present invention, the weight ratio (x/Y) of the weight of the pressurized medium (X) to the weight of the gas generating agent (Y) is preferably 0.1 to 7, more preferably 0.5 to 5.

Moreover, with the hybrid inflator, it is preferable for the pressure index during the burning of the gas generating agent as given by the formula rb=αPⁿ (wherein rb is the burning rate, α is a coefficient, P is the pressure, and n is the pressure index) to be made to be less than 0.8. This pressure index (n) is more preferably made to be 0.1 to 0.8, yet more preferably 0.1 to 0.7.

In the case that the pressure index (n) is made to be less than 0.8 in this way, the burning rate is suppressed from rising suddenly in the initial period of the burning of the gas generating agent, and hence the rise in the pressure inside the housing is low. Consequently, even in the case that the thickness of the housing is reduced, sufficient pressure withstanding ability can be maintained. Moreover, because the rise in the pressure inside the housing is low (i.e. the change in the pressure inside the housing is small), the burning of the gas generating agent is carried out stably, and hence combustion residue is not produced from the gas generating agent.

In the present invention, ‘combustion chamber’ means a chamber having a gas generating function of generating high-temperature combustion gas through burning of a gas generating agent, and ejecting this high-temperature combustion gas into an inflator housing. Moreover, the hybrid inflator comprises such combustion chambers in the inflator housing, with ‘inflator’ meaning a device having a function of ejecting a pressurized medium present inside the inflator housing to the outside and thus inflating an air bag, this being through the action of the high-temperature combustion gas ejected from the combustion chambers, and ‘hybrid’ meaning using a combination of both the pressurized medium and the high-temperature combustion gas generated through the burning of the gas generating agent.

According to the hybrid inflator of the present invention, when, out of the two combustion chambers, only the gas generating agent in one of the combustion chambers is burnt as air bag inflation means, and then to secure the safety of work during disposing of the motor vehicle, the gas generating agent in the other combustion chamber is burnt after a delay of approximately 100 milliseconds from the commencement of the burning of the first gas generating agent, the combustibility of the gas generating agent burnt after the delay is improved. In particular, with the present invention, the combustibility can be improved merely by shielding some of the communication holes with a shielding means, and hence the present invention is excellent in that a large effect is obtained through simple means, and moreover can also be used as means for improving the combustibility with an existing hybrid inflator.

### BRIEF DESCRIPTION OF THE DRAWINGS

FIG. 1 is a longitudinal sectional view of a hybrid inflator.

FIG. 2 is a side view of a partition member.

FIG. 3 is a side view of another embodiment of the partition member.

In the drawing, numerical references are:

100 Hybrid inflator
101 Inflator housing
102 Partition member
115 First openings
121a Second openings (closed off)
121b Second openings (not closed off)
126 concave portion

### DETAILED EXPLANATION OF THE INVENTION

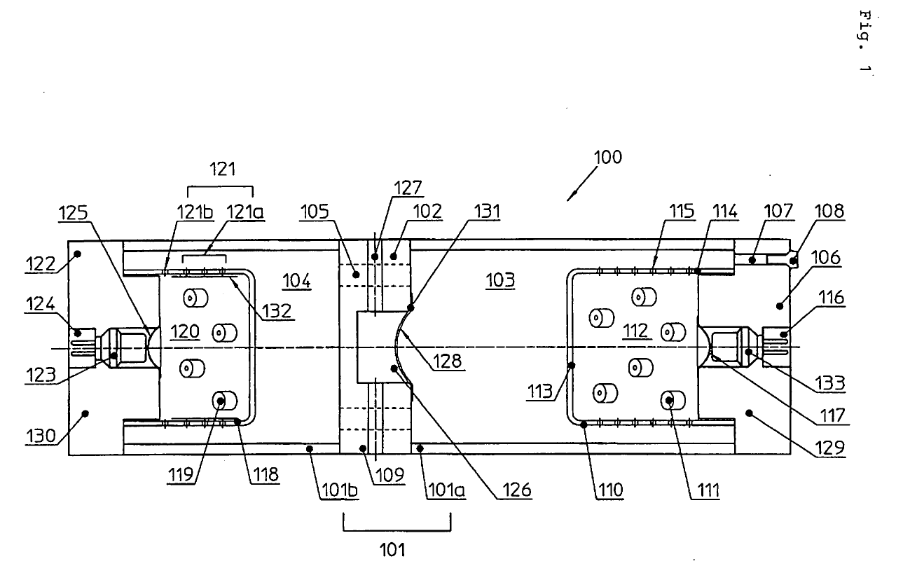

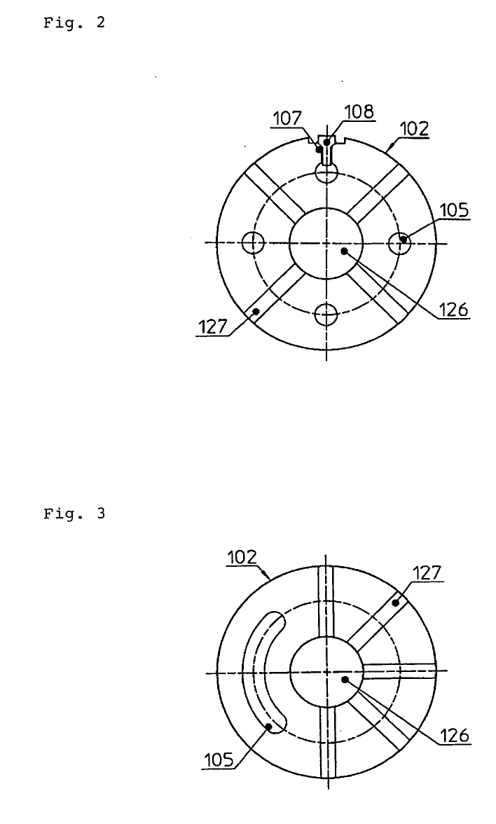

Following is a detailed description of the present invention with reference to the drawings showing embodiments of the present invention. FIG. 1 is a sectional view along the longitudinal direction of an embodiment of a hybrid inflator 100, and FIG. 2 is a sectional view of a partition member 102. FIG. 3 is a sectional view of another embodiment of the partition member 102.

An inflator housing 101 comprises a cylindrical pressure-resistant vessel, and the space therein (pressurized medium charged space) is partitioned into two spaces 103 and 104 by the partition member 102. In the embodiment of FIG. 1, specifically, the housing 101 comprises two cylindrical members 101a and 101b, one end of each abutting against the partition member 102. The abutting portions are fixed by welding or crimping. Alternatively, it is also possible to make the housing comprise one cylinder, dispose the partition member 102 in a predetermined position inside the cylinder, and carry out crimping from the outside of the housing 101 toward the inside, welding or the like, thus fixing the partition member 102 to the housing 101. Each of the spaces 103 and 104 formed inside the housing 101 (103 shall be taken as a first space, and 104 as a second space) is charged with a pressurized medium, and is maintained at a high pressure. In FIG. 1, the partition member 102 is disposed eccentrically from the center of the housing 101 in the axial direction thereof such that the two spaces 103 and 104 have different volumes to one another, but the partition member may be disposed in the center in the axial direction such that the two spaces 103 and 104 have identical volumes.

A first combustion chamber 112 inside which a first gas generating agent 111 is housed is formed through a first combustion chamber housing 110 in the first space 103. One end 113 of the first combustion chamber housing 110 is closed off, and the opposite end 114 is open, and plural first openings 115 are formed in a peripheral wall portion of the first combustion chamber housing 110, so that the pressurized medium communicates with the inside of the first combustion chamber 112 via the first openings 115. Moreover, a first boss 106 is provided in an opening in an end of the hybrid inflator housing 101 on the first combustion chamber 112 side. A first igniter 133 for igniting and burning the first gas generating agent 111 is provided in the first boss 106. The first igniter 133 is provided in an opening portion 116 formed in the first boss 106, and this opening portion is closed off by a first rupturable plate 117 at an end of the opening portion on the first igniter 133 side. The first rupturable plate 117 is fixed by resistance welding or the like in the end of the opening portion 116 of the first boss 106 on the first combustion chamber 112 side.

On the other hand, a second combustion chamber 120 inside which a second gas generating agent 119 is housed is formed through a second combustion chamber housing 118 in the second space 104. As with the first combustion chamber housing 110, one end of the second combustion chamber housing 118 is closed off, and the opposite end is open, and plural second openings 121 are formed in a peripheral wall portion of the second combustion chamber housing 118. Moreover, a second boss 122 is provided in an opening in an end of the hybrid inflator housing 101 on the second combustion chamber 120 side. A second igniter 123 for igniting and burning the second gas generating agent 119 is provided in the second boss 122. The second igniter 123 is provided in an opening portion 124 formed in the second boss 122, and this opening portion is closed off by a second rupturable plate 125 at an end of the second igniter 123. The second rupturable plate 125 is again fixed by resistance welding or the like in the end of the opening portion 124 of the second boss 122 on the second combustion chamber 120 side.

Regarding the plural second openings 121 formed in the peripheral wall portion of the second combustion chamber housing 118, some of the openings 121a out of the second openings 121 are closed off from the inside by an aluminum sealing tape, and the remainder of the openings 121b are not closed off. The pressurized medium inside the housing thus communicates with the inside of the second combustion chamber housing 118 via the second openings 121b that are not closed off. Out of these openings 121a and 121b, it is preferable for the total area A_{2nd-1} of the non-shielded open communication holes 121b to be no more than 50% of the sum A_{2nd} of the total area A_{2nd-2} of the shielded communication holes 121a and the total area A_{2nd-1} of the non-shielded open communication holes 121b.

One end 113 of the first combustion chamber housing 110 is closed off, and the first combustion chamber housing 110 is fixed through a method such as welding or crimping in a state in which an inner peripheral surface of the opposite end 114 has been fitted around a peripheral wall surface of a convex portion 129 formed in the center of the first boss 106. Moreover, the second combustion chamber housing 118 is similarly fixed through a method such as welding or crimping with an inner peripheral surface on the opposite end (opening portion) side having been fitted around a projecting portion 130 of the second boss 122.

The partition member 102 has formed therein plural communication holes 105 that communicate the spaces 103 and 104 together; these communication holes 105 do not impede the movement of gas between the spaces 103 and 104, but rather have an opening area such that gas can move between the spaces instantaneously. The communication holes 105 are thus preferably provided at equal intervals in the partition member 102. The pressurized medium is charged in from a small hole 107 formed in the boss 106 connected to one end of the inflator housing 101, and the small hole 107 is closed up by a sealing pin 108 after the pressurized medium has been charged in. Because of the existence of the communication holes 105, if the pressurized medium is charged into only one of the spaces (e.g. the first space 103), then the pressurized medium will also be charged via the communication holes 105 into the space on the opposite side (e.g. the second space 104). Alternatively, the small hole 107 for charging in the pressurized medium may be provided in a peripheral wall portion 109 of the partition member 102 such as to penetrate into one of the communication holes 105, whereby a similar effect can be obtained. Moreover, a concave portion 126 is formed in the partition member 102 on the first space 103 side thereof, and gas discharge ports 127 are provided communicating with the outside of the housing 101. A main rupturable plate 128 is attached by resistance welding or the like to an end of an opening portion 131 of the concave portion 126 on the first space 103 side. The pressurized medium inside the housing 101 is hermetically sealed inside the housing 101 by the first rupturable plate 117, the second rupturable plate 125 and the main rupturable plate 128.

In FIG. 1, the structure is such that the gas generating agents 111 and 119 are ignited directly by the igniters 133 and 123 respectively, but in the case that the gas generating agents have low ignitability, a conventional transfer charge may be used. Boron niter can be used as a conventional transfer charge, but instead of a conventional transfer charge, for example, a gas generating agent having good ignitability (see the fuels and oxidizing agents listed earlier, e.g. a gas generating agent containing nitroguanidine and strontium nitrate, and optionally also containing a binder) may be used as a transfer charge.

To capture solid residue in the combustion gas generated through the burning of the first gas generating agent 111, a screen comprising wire mesh or the like may be disposed in the first combustion chamber housing 110 (such a screen is not shown in FIG. 1). The screen can be disposed on the inner surface or on the outer peripheral surface of the peripheral wall portion of the first combustion chamber housing 110 to cover the first openings 115.

Moreover, to capture solid residue in the combustion gas generated through the burning of the second gas generating agent 119, a screen comprising wire mesh or the like may be disposed in the second combustion chamber housing 118 (such a screen is not shown in FIG. 1). In this case, the screen can be disposed on the outer peripheral surface of the peripheral wall portion of the second combustion chamber housing 118. Alternatively, a screen may be disposed over the partition member 102 on the second space 104 side thereof to cover the communication holes 105 formed in the partition member 102.

A screen may also be disposed in the space of the concave portion 126 formed in the center of the partition member 102, and used together with the screens disposed in the first and second combustion chamber housings 110 and 118, or a screen may be disposed in the concave portion 126 only.

In FIG. 1, comparing the area of the opening portion 131 of the concave portion 126 formed in the partition member 102 and the total opening area of the gas discharge ports 127, the area of the opening portion 131 is the smaller. The area of the opening portion 131 shall be taken as Aₑₓ. The amount discharged of the combustion gas and the pressurized medium in the housing 101 is thus adjusted through the area Aₑₓ of the opening portion 131.

Some of the openings 121a out of the plural second openings 121 formed in the second combustion chamber housing 118 are closed off from the inside by aluminum sealing tape 132 as a shielding means. There are no limitations on the material, shape and so on of the shielding means, so long as the problem to be solved by the present invention can be solved.

The total area A_{2nd-1} of the non-shielded open second openings 121b, and the area Aₑₓ of the opening portion 131 shown in FIG. 1 satisfy the following formula (I): Aₑₓ>A_{2nd-1} (I)

Furthermore, out of the plural second openings 121, the total area A_{2nd-1} of the non-shielded open communication holes 121b is preferably no more than 50%, more preferably no more than 40%, of the sum A_{2nd} of the total area A_{2nd-2} of the shielded communication holes 121a and the total area A_{2nd-1} of the non-shielded open communication holes 121b.

By closing off some of the second communication holes 121 in this way, when only the first gas generating agent 111 in the first combustion chamber 112 has been burnt as air bag inflation means and then the second gas generating agent 119 in the second combustion chamber 120 is burnt approximately 100 milliseconds later to secure the safety of work during disposing of the motor vehicle, the combustibility of the second gas generating agent 119 at this time can be improved.

Moreover, when formula (I) is satisfied, it is preferable for the total area A₁ₛₜ of the plural first openings 115 in the first combustion chamber housing 110, and Aₑₓ to satisfy the following formula (II): Aₑₓ<A₁ₛₜ (II).

The amount of the second gas generating agent 119 may be made the same as the amount of the first gas generating agent 111 or may be made more or less than the amount of the first gas generating agent 111, and the shape, dimensions, composition, and composition ratio for the second gas generating agent 119 may be the same as or different to the first gas generating agent 111. Moreover, the volumes of the first combustion chamber 112 and the second combustion chamber 120 may be the same as or different to one another.

As described above, the first combustion chamber 112 and the second combustion chamber 120 are communicated with the inside of the housing 101 through the first openings 115 and the second openings 121b respectively, and hence the combustion chambers 112 and 120 are both in a high-pressure state, i.e. the same pressure state as the space inside the inflator housing 101.

Moreover, there is a partition member 102 between the first space 103 and the second space 104, the both spaces being communicated together by the communication holes 105, and hence the second combustion chamber 120 is not readily affected by the actuation (ignition) of the first combustion chamber 112. The second gas generating agent 119 can thus be prevented from being ignited and burnt due to the ignition of the first gas generating agent 111.

The gas discharge ports 127 from which the combustion gas and the pressurized medium inside the housing 101 are discharged are formed at equal intervals in the circumferential direction in the partition member 102. The gas discharge ports 127 communicate with the concave portion 126 that is formed in the center of the partition member 102. In FIG. 1, the area of the opening portion 131 of the concave portion 126 is made to be smaller than the total opening area of the gas discharge ports 127 (in this case, Aₑₓ is the area of the opening portion 131), but the total opening area of the gas discharge ports 127 may be made to be smaller than the area of the opening portion 131 (in this case, Aₑₓ is the total opening area of the gas discharge ports 127).

A₁ₛₜ, A_{2nd-1}, A_{2nd-2} and Aₑₓ preferably satisfy the following formulae (III) to (V):
Aₑₓ<A₁ₛₜ+A_{2nd-1}+A_{2nd-2} (III)
A₁ₛₜ>Aₑₓ×[S₁/(S₁+S₂)] (IV)
A_{2nd-1}+A_{2nd-2}>Aₑₓ×[S₂/(S₁+S₂)] (V)
(wherein S₁ represents the total surface area of the first gas generating agent 111 that is burnt first, and S₂ represents the total surface area of the second gas generating agent 119 that is burnt after a delay).

With the hybrid inflator 100, it is preferable for all of the constituent elements described above to be disposed symmetrically relative to the central axis (the line of alternate long and short dashes in FIG. 1), but at least some of the constituent elements may be disposed eccentrically from the central axis.

A sectional view of the partition member 102 is shown in FIG. 2. The partition member shown in FIG. 2 is the partition member of FIG. 1 as viewed from the first combustion chamber side. Furthermore, there is a difference in that the sealing pin 108 is provided in the first boss 106 in FIG. 1, but is provided in a small hole 107 communicating with one of the communication holes 105 in the partition member in FIG. 2.

With the partition member 102 of FIG. 2, the concave portion 126 is formed in the center of the partition member 102, and the gas discharge ports 127 are formed at equal intervals running radially outward such as to communicate with the concave portion 126. The combustion gas and the pressurized medium inside the housing 101 are thus discharged out via the gas discharge ports 127 uniformly from the concave portion 126. Moreover, the communication holes 105 that communicate the first space 103 and the second space 104 together in the housing 101 are formed between the places where the gas discharge ports 127 are formed. The small hole 107 for charging the pressurized medium into the housing 101 is formed in one of the communication holes 105, and is closed up by the sealing pin 108. As a result, even if the pressurized medium is not charged into each of the first space and the second space, merely by charging in from the small hole 107, the pressurized medium can be charged into both of the spaces via the communication hole 105, and hence the assembly of the inflator (the charging in of the pressurized medium) becomes easy. In FIG. 2, there are four each of the gas discharge ports 127 and the communication holes 105, but there is no limitation on the number or size so long as there are no problems in forming the gas discharge ports 127. Note, however, that it is preferable for the opening area to be sufficiently large that gas can move between the spaces 103 and 104 instantaneously.

Moreover, FIG. 3 shows another embodiment of the partition member 102 (being a sectional view as viewed from the first combustion chamber side). In FIG. 3, gas discharge ports 127 are formed in the right half of the partition member 102, and one communication hole 105 is formed on the left side. When combining the inflator of the present invention with an air bag apparatus on the front passenger side of a vehicle in particular, the inflator is built into the dashboard before the front passenger seat, and hence is preferably disposed to extend sidewise. In this case, there are peripheral wall portions of the inflator facing the passenger side (the side on which the air bag is provided) and facing in a direction opposite to this. By providing the gas discharge ports 127 in the portion facing the passenger side (the air bag side), the outflow of the gas into the air bag can be carried out smoothly. Note that in the embodiment of FIG. 3, again there are no particular limitations on the number or angle of disposition of the gas discharge ports 127. Moreover, there are no particular limitations on the number or shape of the communication holes 105, although the communication holes 105 preferably have a large opening area so that the movement of gas between the spaces 103 and 104 is not impeded and thus the pressurized medium can move between the two spaces instantaneously.

Moreover, the hybrid inflator of the present invention is not limited to that of FIG. 1; for example, the hybrid inflator may have a structure in which the gas discharge ports (closed off with a main rupturable plate) are formed in the peripheral wall portion of the inflator housing 101, or the partition member 102 in FIG. 1 is not used, the two combustion chambers are provided at one end of the housing 101, and the gas discharge ports (closed off with a main rupturable plate) are provided at the opposite end.

An air bag system of the present invention comprises an actuation signal outputting means, which comprises an impact sensor and a control unit, and a module case accommodating an air bag and the hybrid inflator 100. The hybrid inflator 100 is connected to the actuation signal outputting means (the impact sensor and the control unit) on the first igniter 133 side and the second igniter 123 side, and is connected and fixed using fixing means into the module case in which the air bag is provided. With the air bag system having this constitution, actuation signal output conditions are set as appropriate in the actuation signal outputting means, whereby the amount of gas generated can be adjusted in accordance with the degree of impact, and hence the air bag inflation rate can be adjusted.

Next, the operation of the hybrid inflator 100 will be described with reference to FIGS. 1 and 2.

Before actuation of the hybrid inflator 100, the pressurized medium that has been charged at high pressure into the inflator housing 101 flows into the first combustion chamber 112 and the second combustion chamber 120 that are communicated with the inside of the inflator by the first openings 115 and the non-shielded second openings 121b respectively, whereby the first combustion chamber 112 and the second combustion chamber 120 are maintained at a high pressure and at the same pressure.

Upon collision of the vehicle, the first igniter 133 is actuated and ignited by the actuation signal outputting means, and hence the first rupturable plate 117 is ruptured and the first gas generating agent 111 in the first combustion chamber 112 is ignited. At this time, because the pressurized medium has flowed into the first combustion chamber 112 and hence the inside of the first combustion chamber 112 is maintained at high pressure, the burning of the first gas generating agent 111 is stable. Note that because of the existence, in the housing 101, of the partition member 102 having the plural communication holes 105 formed therein, the second gas generating agent 119 is not ignited and burnt through the burning of the first gas generating agent 111.

The high-temperature combustion gas then flows into the inflator housing 101 from the first openings 115, thus increasing the pressure in the inflator housing 101, whereby the main rupturable plate 128 ruptures, and the gas passes through the opening portion 131 into the gas discharge ports 127. The pressurized medium and the combustion gas generated from the first gas generating agent 111 thus pass through the gas discharge ports 127 and inflate the air bag provided in the air bag module (or module case).

At the same time as the actuation of the first igniter 133 or slightly (approximately 10 to 40 ms) thereafter, the second igniter 123 is actuated and ignited by the actuation signal outputting means, and hence the second rupturable plate 125 is ruptured and the second gas generating agent 119 in the second combustion chamber 120 is ignited and burnt, and thus a predetermined amount of high-temperature combustion gas (an amount corresponding to the amount charged of the second gas generating agent 119) is generated. At this time, only a short amount of time has passed since the main rupturable plate 128 was ruptured, and hence the pressurized medium is still present in the second combustion chamber 120 and thus the inside of the second combustion chamber 120 is still maintained at high pressure, and hence the burning of the second gas generating agent 119 is stable.

When the second igniter 123 is actuated at the same time as or slightly after the actuation of the first igniter 133, a rise in pressure occurs rapidly in the second combustion chamber 120, and hence the pressure becomes high, and thus the sealing tape 132 closing off some of the openings 121a out of the second openings 121 is ruptured accompanying the rise in pressure in the second combustion chamber 120 due to the burning of the second gas generating agent 119.

Moreover, if formulae (III) to (V) are satisfied, then when the second gas generating agent 119 is burnt at the same time as or slightly after the first gas generating agent 111, the outflow rate of the pressurized medium and the combustion gas from the inflator housing 101 is controlled only by the opening portion 131 formed in the partition member 102 in FIG. 1, and hence control of this outflow rate is easy.

The high-temperature combustion gas generated when the second gas generating agent 119 is burnt at the same time as or slightly after the first gas generating agent 111 flows into the second space 104 of the inflator housing from the second openings 121 (121a and 121b) in this way, and because of the existence of the communication holes 105, also spreads into the first space 103. The pressure inside the housing 101 is thus increased, and hence the remainder of the pressurized medium is ejected through the ruptured main rupturable plate 128 and out from the concave portion 126 and the gas discharge ports 127, thus further inflating the air bag.

In the case that the hybrid inflator 100 described above generates combustion gas in two stages in this way, through the ignition of the first gas generating agent 111, a delay in the air bag inflation operation upon collision of the vehicle is prevented, and the initial expansion of the air bag is made to be gradual, and moreover through the burning of the second gas generating agent 119, the pressurized medium in the inflator housing 101 can be completely discharged, whereby the air bag can be inflated instantaneously with a sufficient degree of safety.

Moreover, because there are two combustion chambers, it is also possible to handle a mode of implementation in which combustion gas is generated only from the first combustion chamber 112, or combustion gas is generated from the first and second combustion chambers 112 and 120 simultaneously, or the times of commencement of generation of combustion gas in the first and second combustion chambers 112 and 120 are suitably adjusted to have a desired interval therebetween.

In the case that only the first gas generating agent 111 is burnt as the air bag inflation means, to secure the safety of work during disposing of the motor vehicle, the second igniter 123 is then actuated approximately 100 milliseconds later, thus burning the second gas generating agent 119.

At this time, because some of the openings 121a out of the second openings 121 are closed off, and the relationship of formula (I) is satisfied, even if the inside of the second combustion chamber 120 is at a low pressure of approximately atmospheric pressure when the second gas generating agent 119 is burnt, the combustion gas will only flow out from the open openings 121b out of the second openings 121 (i.e. A_{2nd-1} controls the gas outflow amount from the second combustion chamber 120), and hence the pressure in the second combustion chamber 120 is easily shut in. The pressure in the second combustion chamber 120 thus rises, and due to this rise in pressure the burning rate of the second gas generating agent 119 is increased, and hence production of CO and NOₓ is suppressed.

Note that compared with when the pressurized medium is present (i.e. when the first gas generating agent 111 and the second gas generating agent 119 are burnt simultaneously, or when the second gas generating agent 119 is burnt only slightly after the first gas generating agent 111), the pressure inside the second combustion chamber 120 is lower, and hence the burning rate of the second gas generating agent 119 is slow, and thus the rise in the pressure in the second combustion chamber 120 is gradual, and hence the sealing tape 132 closing up the openings 121a out of the second openings 121 is not ruptured.

Consequently, when only the first gas generating agent 111 is burnt, by satisfying formula (II), the outflow rate (outflow amount, outflow pressure) of the pressurized medium and the combustion gas is regulated by the openings 127 (or 131) of the concave portion 126 formed in the partition member 102 in FIG. 1, and thus the burning rate of the first gas generating agent is regulated. After that, when the second gas generating agent 119 is burnt in a state in which the pressure in the inflator housing has dropped down to approximately atmospheric pressure (i.e. 100 milliseconds or more after the actuation of the first igniter 133), the burning rate of the second gas generating agent 119 is controlled through formula (I) being satisfied.

### EXAMPLE

Following is a more detailed description of the present invention through an example; however, the present invention is not limited to this example.

### Example 1

A hybrid inflator as shown in FIG. 1 was manufactured. The details of the various elements were as follows.
Composition of gas generating agent: Nitroguanidine/strontium nitrate/carboxymethyl cellulose Na salt/acid clay=34:50:9:7 (proportions by mass)
Amounts of gas generating agents: 20 g of above gas generating agent used as each of first gas generating agent and second gas generating agent (total 40 g, corresponding to 1 mol of generated gas; pressure index 0.6)
Shape of gas generating agents: Cylinder with single hole (through hole), outside diameter 5 mm, inside diameter 1.2 mm, length 5 mm
Surface area of first gas generating agent (S₁): 13,700 mm²
Surface area of second gas generating agent (S₂): 13,700 mm²
Pressurized medium: 2.6 mol (100 g) of mixed gas with argon:helium=96:4 (molar ratio)
Charging pressure of pressurized medium: 32,000 kPa
A₁ₛₜ (total area of first openings): 120 mm²
A_{2nd-1} (total area of non-shielded open second openings): 17.0 mm²
A_{2nd-2} (total area of shielded second openings): 33.9 mm²
Aₑₓ (area of opening portion of concave portion of partition member): 50.2 mm²
Proportion (%) of A_{2nd-1} out of total area of second openings (A_{2nd-1}+A_{2nd-2})=33.4%
   Aₑₓ (50.2 mm²)>A_{2nd-1}(17.0 mm²) (I)
   Aₑₓ(50.2 mm²)<A₁ₛₜ(120 mm²) (II)
   Aₑₓ(50.2 mm²)<A₁ₛₜ+A_{2nd-1}+A_{2nd-2} (33.9 mm²) (III)
   A₁ₛₜ(120 mm²)>Aₑₓ(50.2 mm²)×[S₁(13700 mm²)/(S₁(13700 mm²)+S₂(13700 mm²))] (IV)
   A_{2nd-1}(17.0 mm²)+A_{2nd-2}(33.9 mm²)>Aₑₓ(50.2 mm²)×[S₂(13700 mm²)/(S₁ (13700 mm²)+S₂ (13700 mm²))] (V)

Using the hybrid inflator 100 shown in FIG. 1, the first igniter 133 was actuated, thus igniting and burning the first gas generating agent 111 in the first combustion chamber 112, and then 100 ms later the second igniter 123 was actuated, thus igniting and burning the second gas generating agent 119 in the second combustion chamber 120. The pressure in the second combustion chamber 120 at this time was approximately 15 MPa (calculated value).

As a comparative example, a similar combustion test was carried out for a hybrid inflator 100 in which none of the second openings 121 were covered with sealing tape. The result was that the pressure in the second combustion chamber 120 was approximately 3.5 MPa.

1. A hybrid inflator for air bag inflation in which the combustibility of a gas generating agent burnt after a delay is improved, the hybrid inflator comprising an inflator housing, a first combustion chamber and a second combustion chamber housed in the inflator housing, a first ignition means and a second ignition means connected to the respective combustion chambers, and gas discharge ports from which gas is discharged;
wherein a pressurized medium charged space inside the inflator housing is charged with a pressurized medium;
a gas discharge path for ejecting a gas containing the pressurized medium into an air bag is provided, and an opening portion for controlling an outflow pressure of the gas is provided in the gas discharge path;
for each of the first combustion chamber and the second combustion chamber, an outer shell is formed through a combustion chamber housing having plural communication holes therein, a first gas generating agent and a second gas generating agent are housed respectively therein, and each of the two combustion chambers is communicated with the pressurized medium charged space of the inflator housing by the plural communication holes;
out of the first and second combustion chambers, the second combustion chamber, in which the gas generating agent is burnt after a delay, has some of the plural communication holes closed off with a shielding means;
and the total area A_{2nd-1} of the non-shielded open communication holes, and the total area Aₑₓ of the opening portion provided in the gas discharge path for controlling the outflow pressure of the gas satisfy the following formula (I):
Aₑₓ>A_{2nd-1} (I)

2. A hybrid inflator for air bag inflation, in which the combustibility of a gas generating agent burnt after a delay is improved, comprising:
an inflator housing formed with a gas discharge port, and defining a space filled with a pressurized medium;
a first combustion chamber housing provided within the inflator housing and defining therein a first combustion chamber including a first gas generating agent, the first combustion chamber housing being provided with a plural communication holes connecting the first combustion chamber to the space;
a second combustion chamber housing provided within the inflator housing and defining therein a second combustion chamber including a second gas generating agent that is ignited later than the first gas generating agent, the second combustion chamber housing being provided with a non-shielded open communication holes connecting the second combustion chamber and the space and a shielded communication holes connecting the second combustion chamber and the space when the shielded communication holes open, the non-shielded open communication holes having a total open area A_{2nd-1};
a first ignition means connected to the first combustion chamber;
a second ignition means connected to the second combustion chambers,
a gas discharge path connecting the gas discharge port to the space, and including an opening portion for controlling an outflow of the pressurized medium, the opening portion having a total area Aₑₓ satisfying the following formula (I)
Aₑₓ>A_{2nd-1} (I).

3. The hybrid inflator according to claim 1 or 2, wherein out of a plural communication hole possessed by the second combustion chamber, the total area A_{2nd-1} of the non-shielded open communication holes is no more than 50% of the sum A₂nd of the total area A_{2nd-2} of the shielded communication holes and the total area A_{2nd-1} of the non-shielded open communication holes.

4. The hybrid inflator according to claim 3, wherein the total area A₁ₛₜ of the plural communication holes possessed by the first combustion chamber, and Aₑₓ satisfy the following formula (II):
Aₑₓ<A₁ₛₜ (II).

5. The hybrid inflator according to claim 4, wherein A₁ₛₜ, A_{2nd-1}, A_{2nd-2} and Aₑₓ satisfy the following formulae (III) to (V):
Aₑₓ<A₁ₛₜ+A_{2nd-1}+A_{2nd-2} (III)
A₁ₛₜ>Aₑₓ×[S₁/(S₁+S₂)] (IV)
A_{2nd-1}+A_{2nd-2}>Aₑₓ×[S₂/(S₁+S₂)] (V)
(wherein S₁ represents the total surface area of the first gas generating agent burnt first, and S₂ represents the total surface area of the second gas generating agent burnt after a delay).

6. The hybrid inflator according to claim 1 or 2, wherein the opening portion provided in the gas discharge path for controlling the outflow pressure of the gas is formed in a partition member provided in a central portion of the inflator housing.

7. An air bag system comprising an actuation signal outputting means, which comprises an impact sensor and a control unit, and a module case in which are housed an air bag and the hybrid inflator according to claim 1 or 2.
